(19) United States
(12) Patent Application Publication
(10) Pub. No.: US 2020/0388130 A1
(43) Pub. Date: Dec. 10, 2020

(54) SYSTEM, METHOD, AND APPARATUS FOR REPORTING A THREAT TO AN ESTABLISHMENT

(71) Applicant: Invictus Apps, Inc., New Haven, CT (US)

(72) Inventors: Neal SONI, Westport, CT (US); Michael CHIME, Broadview Heights, OH (US); Dylan GLEICHER, Fairfield, CT (US); Daniel JAMES, Baton Rouge, LA (US)

(21) Appl. No.: 16/896,089

(22) Filed: Jun. 8, 2020

Related U.S. Application Data
(60) Provisional application No. 62/858,921, filed on Jun. 7, 2019.

(51) Int. Cl. G08B 21/02; G08B 29/16; H04L 29/08; G06F 3/0482; G06F 3/0484

(52) U.S. Cl. CPC G08B 21/02; G08B 29/16; G06F 3/0484; G06F 3/0482; H04L 67/306

(57) ABSTRACT

Systems, methods, and corresponding apparatus for managing an impending threat to an institution, such as an educational institution is described.

### CROSS-REFERENCE TO RELATED APPLICATIONS

This application claim priority to and the benefit of U.S. Application No. 62/858,921, filed on Jun. 7, 2019, the entire teachings of which is incorporated by reference herein.

### FIELD

The present disclosure generally relates to systems and corresponding methods and apparatus for managing an impending situation, and more particularly to systems and corresponding methods and apparatus for managing an impending threat to a facility or an institution.

### BACKGROUND

In the recent decades, violence has become a reality at many American schools. Some studies show that since 2010, there have been about 400 school shootings. Many of these shootings have occurred during school hours, while the students were in school and/or while classes were in session. In all these incidents, about 200 individuals have been killed.

Many American schools have implemented lock-down and shelter-in-place mechanisms and routinely conduct lock-down drills to prepare faculty and students for such situations. However, many of these mechanisms rely on conventional methods (e.g., announcing the lock-down over the school intercom system) to manage impending threats (e.g., initiate or terminate a lock-down or shelter-in-place order).

### BRIEF SUMMARY

The present disclosure generally relates to managing an impending threat to an institution, such as an educational institution. In one aspect, a system for managing an impending threat to an educational institution can comprise at least one processor, and a plurality of graphical user interfaces, and a controller. The controller can be coupled to the processor and the graphical user interfaces and configured to present to each member of the educational institution a graphical user interface. The graphical user interface presented to any given member of the educational institution can be selected by the controller based on a profile of that member. The graphical user interface presented to each user can comprise at least one threat-reporting user interface configured for reporting an impending threat. The at least one threat-reporting user interface can comprise one or more graphical elements for reporting the impending threat. The controller, in response to reporting of the impending threat via the threat-reporting user interface, can dynamically update the user interface presented to the user. The update to the user interface of each member can be based on the profile of that member.

In another aspect, a system for managing an impending threat to an educational institution can comprise at least one processor and a controller coupled to the processor. The controller can be configured to present to each of a plurality of members of the educational institution a user interface based on a profile of that member. The controller can be further configured to dynamically update the user interface in response to reporting of an impending threat and/or one or more actions taken by one or more of the members following the reporting of the threat.

In other examples, the aspects above, or any system, method, apparatus described herein can include one or more of the following features.

The members can have at least one of the following profiles: a student profile, a teacher profile, an administrator profile, and a parent profile. The controller can be in communication with a database that stores these profiles and be configured to access the database and/or receive the profiles from the database.

In some embodiments, the updated user interface that is presented to a member can include one or more graphical elements for allowing the member to react to the threat report. The one or more graphical elements of the updated user interface can allow the member to perform at least one of the following actions: confirming the reported threat, requesting assistance, initiating a threat-management protocol, sending information, and marking safety.

In response to reporting of the threat, the controller can present to a teacher member of the educational facility a user interface that includes a plurality of graphical elements for performing at least one of the following functions: confirming the threat report, providing information, and/or requesting assistance. Alternatively or additionally, in response to reporting of the threat, the controller can present to an administrator member of the educational facility a user interface that comprises graphical elements configured to allow the administrator to initiate at least one of: a lock-down, an evacuation, a shelter-in-place protocol, a silent lock-down. Upon initiation of any of these actions by the administrator, the processor can effect transmission of a notification indicative of the action initiated by the administrator to other members of the educational facility. Further, in response to reporting of the threat, the controller can present to a teacher member of the educational facility a user interface that includes a plurality of graphical elements configured to allow the teacher to perform at least one of the following functions: requesting assistance, sending information, and marking safe.

Additionally or alternatively, in response to reporting of the threat, the controller can present to an administrator member of the educational facility a user interface that includes a plurality of graphical elements configured to allow the administrator to perform at least one of the following functions: ending the lock-down, ending the evacuation, sending an update, and calling emergency services. Further, in response to reporting of the threat, the controller can present to a student member of the educational facility a user interface that includes a plurality of graphical elements configured to allow the student member to perform at least one of the following functions: requesting assistance, marking safe, and providing information to proper authorities. Furthermore, in response to selection of at least one of the graphical elements by a student member to provide information, the controller can update the user interfaces of any of other members (e.g., teacher member, parent member, or administrator member) to facilitate responding to or reacting to the information provided by that student. Further, the dynamically updated user interface(s) described herein can allow the members of the educational facility to respond to or react to reporting of the threat and/or any actions taken following the reporting of the threat.

Other aspects and advantages of the embodiments disclosed herein can become apparent from the following drawings and description, all of which illustrate the principles of the embodiments, by way of example only.

### BRIEF DESCRIPTION OF THE DRAWINGS

FIG. 1A depicts an example of an interface that can be presented to a teacher member of an educational facility according to embodiments disclosed herein.

FIG. 1B depicts another example of an interface that can be presented to a teacher member of an educational facility according to embodiments disclosed herein.

FIG. 1C depicts yet another example of an interface that can be presented to a teacher member of an educational facility according to embodiments disclosed herein.

FIG. 1D depicts another example of an interface that can be presented to a teacher member of an educational facility according to embodiments disclosed herein.

FIG. 2A depicts an example of an interface that can be presented to an administrator member of an educational facility according to embodiments disclosed herein.

FIG. 2B depicts another example of an interface that can be presented to an administrator member of an educational facility according to embodiments disclosed herein.

FIG. 2C depicts yet another example of an interface that can be presented to an administrator member of an educational facility according to embodiments disclosed herein.

FIG. 2D depicts another example of an interface that can be presented to an administrator member of an educational facility according to embodiments disclosed herein.

FIG. 3 depicts an example of an interface that can be presented to a student member of an educational facility according to embodiments disclosed herein.

FIG. 4 is a block diagram of a communications system according to an illustrative embodiment disclosed herein.

FIG. 5 is an example illustration of digital electronic circuitry or computer hardware that can be used with the embodiments disclosed herein.

### DETAILED DESCRIPTION

In one aspect, a system for managing an impending threat to an educational institution is disclosed, which comprises at least one computer processor, a plurality of graphical user interfaces, a controller coupled to the processor and the graphical user interfaces and configured to present to each of a plurality of members of the educational institution selected ones of the user interfaces based on a profile of the member. For each of the members, the selected ones of the user interfaces presented to that member comprise at least one threat-reporting user interface for reporting an impending threat. The threat-reporting user interface comprises a graphical element for reporting the impending threat. In response to reporting of the impending threat via the threat-reporting user interface, the controller dynamically updates a user interface presented to each of the plurality of members from among the plurality of user interfaces and based on a profile of that member.

The profile of a member may be based on the function that member performs in a community associated with the educational institution. For example, a member can be any of a student, a teacher, an administrator, other staff of the educational institution, and/or a parent. In some embodiments, the profiles can include at least one of: student, teacher/faculty, school Administrator, School Resource Officers SRO (On-campus police), Specialized Response Groups (SRG) (Anti-bullying staff, EMS certified staff, etc.), district administrator, first responder, and/or parent profile.

The updated user interface presented to a member can include one or more graphical elements for allowing the member to react to the threat report. For example, the graphical element(s) of an updated user interface can allow the member to at least one of: confirm the report, request assistance, initiate a threat-management protocol, send information, and mark safety.

In some embodiments, in response to the reporting of the threat, the controller presents to each teacher one of the user interfaces that includes a plurality of graphical elements for any of confirming the threat report, providing information or requesting assistance.

In response to the reporting of the threat, the controller presents to each administrator one of the user interfaces comprising a graphical element configured to allow the administrator to initiate at least one of: a lock-down, an evacuation, a shelter-in-place protocol, a silent lock-down, wherein upon initiating any of the actions the processor effects transmission of a notification indicative of the action to the members. Further, in response to initiation of any of the actions by the administrator, the controller can present to each teacher one of the user interfaces that includes a plurality of graphical elements for any of requesting assistance, sending information, and marking safe. Furthermore, in response to initiation of any of the actions by the administrator, the controller presents to each administrator one of the user interfaces that includes a plurality of graphical elements for any of ending the lock-down, ending the evacuation, sending an update, and calling emergency services.

In some embodiments, the interfaces can provide one or more graphical features for performing at least one of the following functionalities: report emergencies by students or teachers, responding to emergencies by administrators, specialized response groups, and/or first responders, providing emergency responses, sending push notifications to students, teachers, administrators, parents, transmitting text messages, allowing for specialized groups to respond to reports, calling other users through a user's phone, calling police by administrator members or teacher members, providing chat communication (e.g., district-wide), providing push notifications alerts (e.g., district-wide), transmitting email (e.g., district-wide).

Additionally or alternatively, in response to initiation of any of the above actions by the administrator, the controller presents to each student one of the user interfaces that includes one or more graphical elements for any of requesting assistance, marking safe and providing information to proper authorities.

In some embodiments, in response to selection at least one of the graphical elements by a student to provide information, the controller updates the user interfaces of any of the teachers and the administrators to facilitate reacting to the information provided by the student. The controller can be in communication with a database for receiving a profile of each of the members.

In a related aspect, a system for managing an impending threat to an educational institution is disclosed, which comprises at least one processor, a controller coupled to the processor and configured to present to each of a plurality of members of the educational institution a user interface based on a profile of the member, where the controller is configured to dynamically update the user interface in response to reporting of an impending threat and one or more actions taken by one or more of the members following the reporting of the there. The dynamically updated user interface allows the member to react to any of the reporting of the threat and the one or more actions taken following the reporting of the threat.

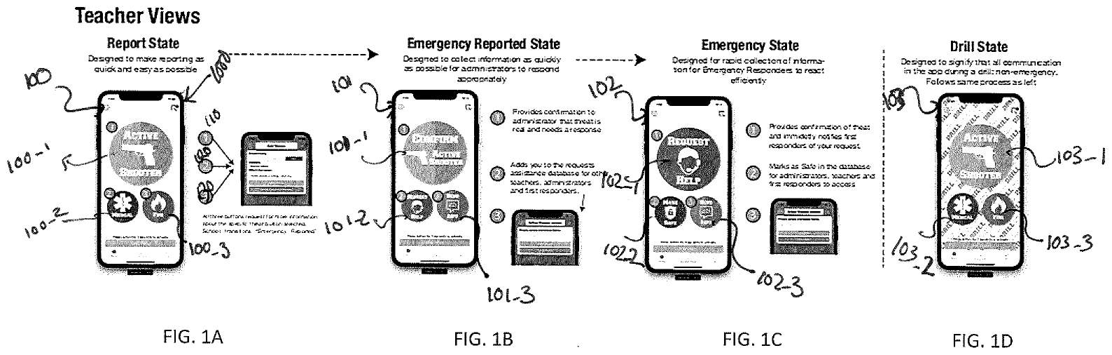

FIG. 1A depicts an example of an interface 100 that can be presented to a teacher member of an educational facility according to embodiments disclosed herein. As shown, the interface 100 can provide a teacher member with a reporting state in which the teacher member can utilize one or more graphical elements 100-1, 100-2, 100-3 to report various situations and conditions (e.g., a state of threat). In the example shown in FIG. 1A, the teacher member is presented with graphical elements 100-1, 100-2, 100-3 that allow reporting of an active shooting 100-1, reporting of a medical emergency 100-2, or reporting of a fire 100-3. It should be understood that the interface 101 can provide the member (e.g., teacher member) with any suitable means of reporting a situation or a condition.

Although described in the context of an educational institution, embodiments disclosed herein can be used in any establishment for reporting any suitable situation and/or threat (shooting, burglary, fire, crimes, etc.). The interface 100 can also be configured such that interfaces on a device implementing the interface (e.g., mobile phone or digital tablet) can be used to control the interfaces or graphical elements. For example, as shown in FIG. 1A, existing buttons 110, 120, 130 on a device 1000 implementing the interface can be used to perform various functions, for example request more information about the specific threat, report an emergency, and/or transition between various screens that may be included in the interface or allow for selection of the various elements 100-1, 100-2, 100-3 of the interface 100.

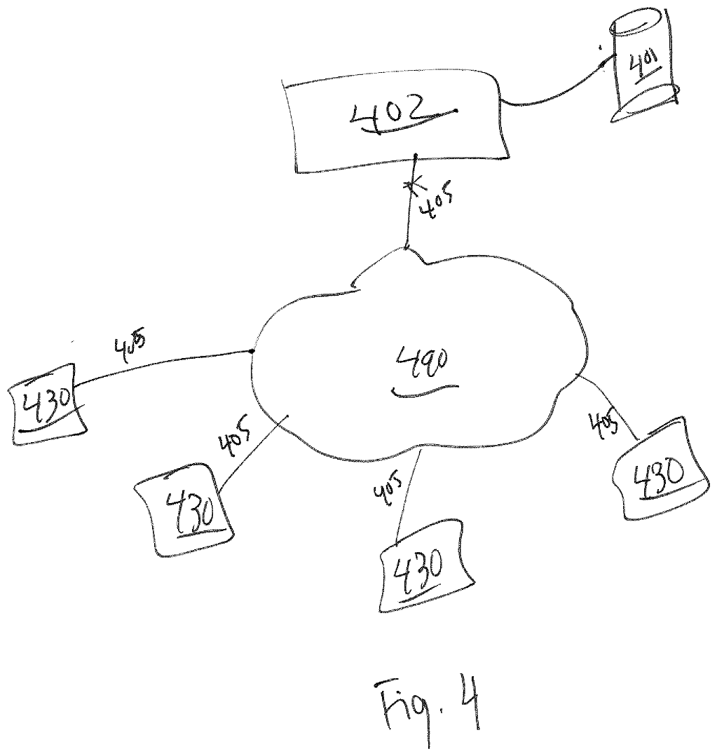

FIG. 1B depicts another example of an interface 101 that can be presented to a teacher member of an educational facility according to embodiments disclosed herein. In this state, the system described herein can collect information as quickly as possible and forward the collected information to appropriate authorities and administrators so that they can quickly respond to the situation at hand. As shown, the interface 101 can provide a teacher member with an interface in which the teacher member can utilize one or more graphical elements 101-1, 101-2, 101-3 to report and/or confirm various situations and conditions (e.g., confirm a state of threat), send information regarding an existing situation, and/or request assistance or help with an ongoing situation. In the example shown in FIG. 1B, the teacher member is presented with graphical elements 101-1, 101-2, 101-3 that allow the teacher to report that situation (e.g., an active shooter) is present 100-1, request help or assistance with the situation 100-2, and/or report/send information regarding the situation 100-3. Using these graphical components, the interface 101 can allow the teacher member to provide confirmation to an administrator that the threat is real and that a response is required. Further, the interface can be coupled to a database (shown in FIG. 4) that is configured to receive a request for assistance from the interface and forward the request to other teachers, administrators, or first responders.

FIG. 1C depicts yet another example of an interface 102 that can be presented to a teacher member of an educational facility according to embodiments disclosed herein. As shown in FIG. 1C, upon confirmation of a state of threat, the teacher member can be presented with an interface 102 that provides the teacher member with required graphical elements to handle an emergency situation. The emergency state can provide for rapid collection of information for emergency responders so that they can quickly and efficiently respond to the situation. The teacher member can use the graphical elements 102-1, 102-2, 102-3 to request help and provide confirmation of threat and immediately notify first responders of the request for help (graphical element 102-1), mark as safe in the database for administrators, teachers, and first responders to access (graphical element 102-2), and/or provide additional information regarding the situation (graphical element 102-3).

FIG. 1D depicts another example of an interface 103 that can be presented to a teacher member of an educational facility according to embodiments disclosed herein. As shown in FIG. 1D, the interface 103 can comprise a drill state that can be used during lock down and/or safety drills to report non-emergency drills of an active shooter 103-1, request medical help 103-2, or report fire 103-3.

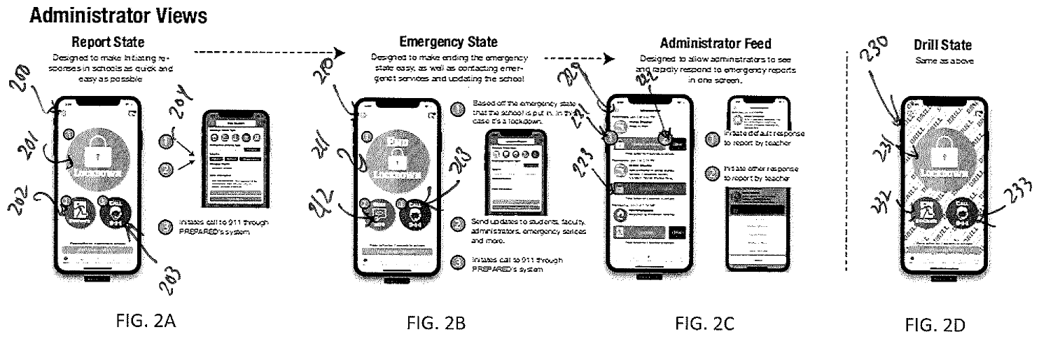

FIG. 2A depicts an example of an interface 200 that can be presented to an administrator member of an educational facility according to embodiments disclosed herein. As shown, the interface 200 can provide an administrator member with a reporting state in which the administrator member can utilize one or more graphical elements 201, 202, 203 to provide an appropriate response to situations and conditions (e.g., a state of threat) observed and/or reported by other members (teachers or students). In the example shown in FIG. 2A, the administrator member is presented with graphical elements that allow initiating a lock-down 201, ordering an evacuation 202, and/or contacting authorities 203 (e.g., by calling 911).

FIG. 2B depicts another example of an interface 210 that can be presented to an administrator member of an educational facility according to embodiments disclosed herein. As shown, the interface 210 can provide an administrator member with an emergency state in which the administrator member can utilize one or more graphical elements 211, 212, 213 to provide an appropriate response to situations and conditions (e.g., a state of threat) observed and/or reported by other members (teachers or students). In the example shown in FIG. 2B, the administrator member is presented with graphical elements that allow ending a lock-down 211, sending information about an ongoing situation 212, and/or contacting authorities 203 (e.g., by calling 911).

FIG. 2C depicts yet another example of an interface 220 that can be presented to an administrator member of an educational facility according to embodiments disclosed herein. As shown, the interface 220 can provide the administrator with a tool configured to allow administrators to see and rapidly respond to emergency reports in one screen. For example, as shown, the interface 220 can allow the administrator to initiate a default response 221 (e.g., lock down) or another appropriate response, perform other functions 222 (e.g., contact authorities), obtain information on an ongoing situation 223 (e.g., active shooter in a hallway).

FIG. 2D depicts another example of an interface that can be presented to an administrator member of an educational facility according to embodiments disclosed herein. As shown in FIG. 2D, the interface 230 can comprise a drill state that can be used during lock down and/or safety drills to report non-emergency drills of a lock down 231, evacuation order 232, or establishing connection with appropriate authorities.

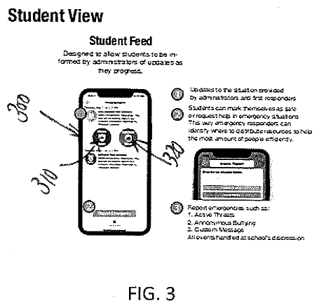

FIG. 3 depicts an example of an interface 300 that can be presented to a student member of an educational facility according to embodiments disclosed herein. The student interface 300 can be configured to allow students to be informed by administrators of updates to an ongoing situation as the situation progresses. As shown, the interface can include one or more graphical components 310 that can be configured to allow a student member to mark him/herself as safe or request help (component 320) in emergency situations. In this way emergency responders can identify where to distribute resources to help the largest group of people efficiently.

FIG. 4 is a block diagram of a communications system 400 according to an illustrative embodiment disclosed herein. The communications system 400 includes a server 402 that is coupled, via a communications network 490, with a number of communications devices 430.

The devices 430 can be interconnected and are in communications with one another. Specifically, the communications devices 430 can be directly connected to one another, via a number of direct links 405, or connect to one another through the communications network 490. The communication devices 430 can also be connected to the server 402 and configured to send and receive information to the server 402.

The network 490 can be a private network (e.g., local area network (LAN)), a metropolitan area network (MAN), a wide area network (WAN), or a public network (e.g., the Internet). The communications network 490 can be a hybrid communications network 190 that includes all or parts of other networks. The networks 490 can have various topologies (e.g., bus, star, or ring network topologies).

The communications devices can be communications devices that are capable of establishing a connection to the communications network 490 and/or other communications devices. Examples of the communications devices that can be used with the embodiments disclosed herein include, but are not limited to, workstations, wireless phones, smart phones, personal digital assistants, desktop computers, laptop computers, tablet computers, handheld computers, smart phones, etc. The communications devices can connect to one another and the network 490 via a number of links 405. Depending on the type of the communications device used (e.g., wired or wireless device), the links 405 can be wired or wireless links.

The server 402 can be configured to monitor and/or track the communications devices 430 and/or store a profile associated with each communications device 430 in a database 401. The server 402 can be any kind of a server and offer a wide range of services. For example, the server 402 can be a web server, database server, file server, mail server, gaming server, etc. The profiles stored by the server can maintain information that can be used to identify each communications device 430. For example, the server 402 can maintain information (e.g., login and password information) that can be used to uniquely identify and/or authenticate a communications device user. In some embodiments, the server 402 can maintain information (e.g., IP addresses) that can be used to uniquely identify a communications device 430.

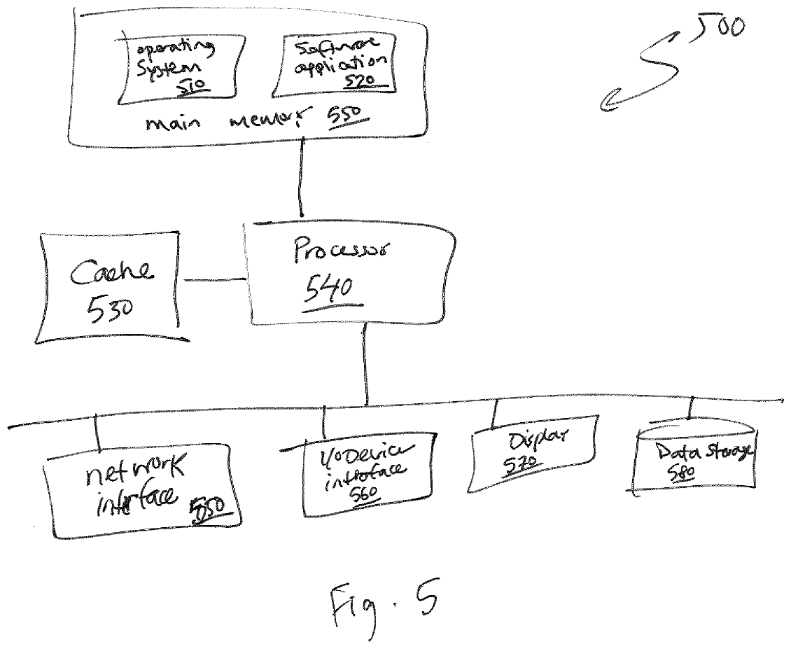

FIG. 5 is an example illustration of digital electronic circuitry 500 or computer hardware that can be used with the embodiments disclosed herein. Without limitation, the techniques described herein can be implemented in digital electronic circuitry or in computer hardware that executes firmware, software, or combinations thereof, for example. The implementation can be as a computer program product, e.g., a computer program tangibly embodied in a machine-readable storage device, for execution by, or to control the operation of, data processing apparatus, e.g., a programmable processor, a computer, or multiple computers.

A computer program can be written in any programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communications network.

One or more programmable processors execute a computer program to perform functions of the invention, or method steps described herein, by operating on input data and generating output. Method steps can also be performed by, and apparatus can be implemented as, special purpose logic circuitry, e.g., an FPGA (field programmable gate array) or an ASIC (application specific integrated circuit). Modules can refer to portions of the computer program and/or the processor/special circuitry that implements that functionality.

The digital electronic circuitry 500 can include a main memory unit 505 coupled to a processor 540. In some embodiments, the main memory unit 505 can be coupled with a cache unit 530, which is responsible for storing copies of the data from the most frequently used main memory 505 locations. The processor 540 can be connected to various interfaces via an input/output (I/O) device interface 560. Processors 540 suitable for the execution of a computer program include, by way of example, both general and special purpose microprocessors, and any one or more processors of any kind of digital computer. Generally, a processor 540 will receive instructions and data from the main memory 505 (e.g., a read-only memory or a random access memory or both). The essential elements of a computer are the processor 540 for executing instructions and one or more memory devices (e.g., main memory 205) for storing instructions and data.

The memory unit 505 can hold various computer executable instructions and data structures including computer executable instructions and data structures that implement aspects of the techniques described herein. The memory unit 505 can also include an operating system and can be arranged to implement various conventional operating system functions including task and process scheduling, memory management, and controlled access to various devices, such as a data storage unit 580. The processes may include computer-executable instructions and data that are configured to implement various aspects of the techniques described herein.

Machine-readable storage devices suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

Generally, the digital electronic circuitry 500 can also include, or be operatively coupled to receive data from or transfer data to, or both, one or more mass storage devices for the storing data 580, e.g., magnetic, magneto-optical disks, or optical disks. Data transmission and instructions can also occur over a communications network. Connection to the communications network can be provided using a network interface 550 coupled to the processor 540.

Embodiments disclosed herein can use any suitable transmission technology, such as mesh networks, Bluetooth®, etc.

What is claimed is:

1. A system for managing an impending threat to an educational institution, comprising:
at least one processor;
a plurality of graphical user interfaces; and
a controller coupled to the processor and the graphical user interfaces and configured to present to each of a plurality of members of said educational institution selected ones of said user interfaces based on a profile of said member;
wherein, for each of said members, said selected ones of the user interfaces presented to that member comprise at least one threat-reporting user interface for reporting an impending threat, said threat-reporting user interface comprising a graphical element for reporting said impending threat, and
wherein in response to reporting of said impending threat via said threat-reporting user interface, said controller dynamically updates a user interface presented to each of said plurality of members from among said plurality of user interfaces and based on a profile of that member.

2. The system of claim 1, wherein said members have at least one of the following profiles: student, teacher, administrator and parent.

3. The system of claim 1, wherein said updated user interface presented to a member includes one or more graphical elements for allowing said member to react to said threat report.

4. The system of claim 2, wherein said one or more graphical elements of the updated user interface allows the member to at least one of: confirm the report, request assistance, initiate a threat-management protocol, send information, and mark safety.

5. The system of claim 2, wherein ire response to reporting of said threat, the controller presents to each teacher one of said user interfaces that includes a plurality of graphical elements for any of confirming the threat report, providing information or requesting assistance.

6. The system of claim 2, wherein in response to reporting of said threat, said controller presents to each administrator one of said user interfaces comprising a graphical element configured to allow the administrator to initiate at least one of: a lock-down, an evacuation, a shelter-in-place protocol, a silent lock-down, wherein upon initiating any of said actions the processor effects transmission of a notification indicative of said action to said members.

7. The system of claim 6, wherein in response to initiation of any of said actions by the administrator, said controller presents to each teacher one of said user interfaces that includes a plurality of graphical elements for any of requesting assistance, sending information, and marking safe.

8. The system of claim 6, wherein in response to initiation of any of said actions by the administrator, said controller presents to each administrator one of said user interfaces that includes a plurality of graphical elements for any of ending the lock-down, ending the evacuation, sending an update, and calling emergency services.

9. The system of claim 6, wherein in response to initiation of any of said actions by the administrator, said controller presents to each student one of said user interfaces that includes one or more graphical elements for any of requesting assistance, marking safe and providing information to proper authorities.

10. The system of claim 1, wherein said controller is in communication with a database for receiving a profile of each of said members.

11. The system of claim 9, wherein in response to selection of at least one of said graphical elements by a student to provide information, the controller updates the user interfaces of any of said teachers and said administrators to facilitate reacting to the information provided by said student.

12. A system for managing an impending threat to an educational institution, comprising:
at least one processor; and
a controller coupled to the processor and configured to present to each of a plurality of members of said educational institution a user interface based on a profile of said member;
wherein said controller is configured to dynamically update said user interface in response to reporting of an impending threat and one or more actions taken by one or more of said members following the reporting of the threat.

13. The system of claim 12, wherein said dynamically updated user interface allows the member to react to any of said reporting of the threat and said one or more actions taken following the reporting of the threat.
